(19) United States
(12) Patent Application Publication
(10) Pub. No.: US 2012/0147150 A1
(43) Pub. Date: Jun. 14, 2012

(54) ELECTRONIC EQUIPMENT

(75) Inventors: Kazuhiro KOJIMA, Osaka (JP); Shinpei FUKUMOTO, Osaka (JP)

(73) Assignee: SANYO ELECTRIC CO., LTD., Moriguchi City (JP)

(21) Appl. No.: 13/315,674

(22) Filed: Dec. 9, 2011

(30) Foreign Application Priority Data
Dec. 10, 2010 (JP) 2010-275593

(51) Int. Cl. H04N 13/02

(52) U.S. Cl. 348/50; 348/E13.074

(57) ABSTRACT

Electronic equipment is equipped with a distance information generating portion that generates distance information of a subject group. The distance information generating portion includes a first distance detecting portion that detects a distance of the subject group based on a plurality of input images obtained by simultaneously photographing the subject group from different visual points, a second distance detecting portion that detects a distance of the subject group by a detection method different from the detection method of the first distance detecting portion, and a combining portion that generates the distance information based on a detection result of the first distance detecting portion and a detection-result of the second distance detecting portion.

### CROSS-REFERENCE TO RELATED APPLICATIONS

This nonprovisional application claims priority under 35 U.S.C. §119(a) on Patent Application No. 2010-275593 filed in Japan on Dec. 10, 2010, the entire contents of which are hereby incorporated by reference.

### BACKGROUND OF THE INVENTION

1. Field of the Invention

The present invention relates to electronic equipment such as an image pickup apparatus or a personal computer.

2. Description of Related Art

There is proposed a function of adjusting a focused state of a photographed image by image processing, and a type of processing for realizing this function is also called digital focus. In order to perform the digital focus, distance information of a subject in the photographed image is necessary.

As a general method of obtaining the distance information, there is a stereovision method using a two-eye camera. In the stereovision method, first and second images are photographed simultaneously using first and second cameras having a parallax, and the distance information is calculated from the first and second images using a triangulation principle.

Note that there is also proposed a technique in which phase difference pixels for generating a signal depending on distance information are embedded in an image sensor, and the distance information is generated from outputs of the phase difference pixels.

Using the stereovision method, it is possible to detect relatively accurate distance information of a subject located within a common photographing range of the first and second cameras. However, in the stereovision method, a subject distance of a subject located within a non-common photographing range cannot be detected in principle. In other words, it is impossible to detected distance information of a subject existing only in one of the first and second images. The focused state adjustment by the digital focus cannot be performed for a region in which the distance information cannot be detected. In addition, the distance information may not be detected accurately by the stereovision method for some subjects in a certain case. The focused state adjustment by the digital focus cannot function appropriately for a region in which accuracy of the distance information is low.

A use of the distance information for the digital focus is described above, but the same problem occurs also in the case where the distance information is used for an application other than the digital focus.

### SUMMARY OF THE INVENTION

Electronic equipment according to the present invention includes a distance information generating portion that generates distance information of a subject group. The distance information generating portion includes a first distance detecting portion that detects a distance of the subject group based on a plurality of input images obtained by simultaneously photographing the subject group from different visual points, a second distance detecting portion that detects a distance of the subject group by a detection method different from the detection method of the first distance detecting portion, and a combining portion that generates the distance information based on a detection result of the first distance detecting portion and a detection result of the second distance detecting portion.

### BRIEF DESCRIPTION OF THE DRAWINGS

FIG. 1 is a schematic general block diagram of an image pickup apparatus according to an embodiment of the present invention.

FIG. 2 is an internal structural diagram of one of image pickup portions illustrated in FIG. 1.

FIG. 3 is a diagram illustrating a relationship between an image space XY and a two-dimensional image.

FIG. 4A is a diagram illustrating a photographing range of a first image pickup portion, FIG. 4B is a diagram illustrating a photographing range of a second image pickup portion, and FIG. 4C is a diagram illustrating a relationship between the photographing ranges of the first and second image pickup portions.

FIGS. 5A and 5B are diagrams illustrating first and second input images obtained by photographing the same point light source simultaneously, and FIG. 5C is a diagram illustrating a relationship between a position of a point image on the first input image and a position of a point image on the second input linage.

FIG. 6 is an internal block diagram of a distance information generating portion.

FIGS. 7A and 7B are diagrams illustrating first and second input images photographed simultaneously, and FIG. 7C is a diagram illustrating a range image based on the input images.

FIG. 8 is a diagram illustrating a digital focus portion that can be disposed in a main control portion illustrated in FIG. 1.

FIG. 9 is a diagram illustrating a positional relationship among the photographing ranges of the two image pickup portions and a plurality of subjects.

FIG. 10 is a diagram illustrating a structure of a second distance detecting portion according to a first embodiment of the present invention.

FIG. 11 is a diagram illustrating an input image sequence according to the first embodiment of the present invention.

FIG. 12 is a diagram illustrating a manner in which image data of one input image is supplied to the second distance detecting portion according to a third embodiment of the present invention.

FIG. 13 is a diagram illustrating a manner in which one input image is divided into a plurality of small blocks according to a fourth embodiment of the present invention.

FIG. 14 is a diagram illustrating a relationship between a lens position and an AF score according to the fourth embodiment of the present invention.

FIG. 15 is a diagram illustrating a relationship between first and second permissible distance ranges according to a fifth embodiment of the present invention.

FIG. 16 is a variation internal block diagram of the distance information generating portion.

### DETAILED DESCRIPTION OF THE PREFERRED EMBODIMENTS

Hereinafter, embodiments of the present invention will be described in detail with reference to the attached drawings. In the drawings, the same portion is denoted by the same reference numeral or symbol, and overlapping description of the same portion is omitted as a rule. Before describing first to sixth embodiments, common matters or references for the embodiments will be described first.

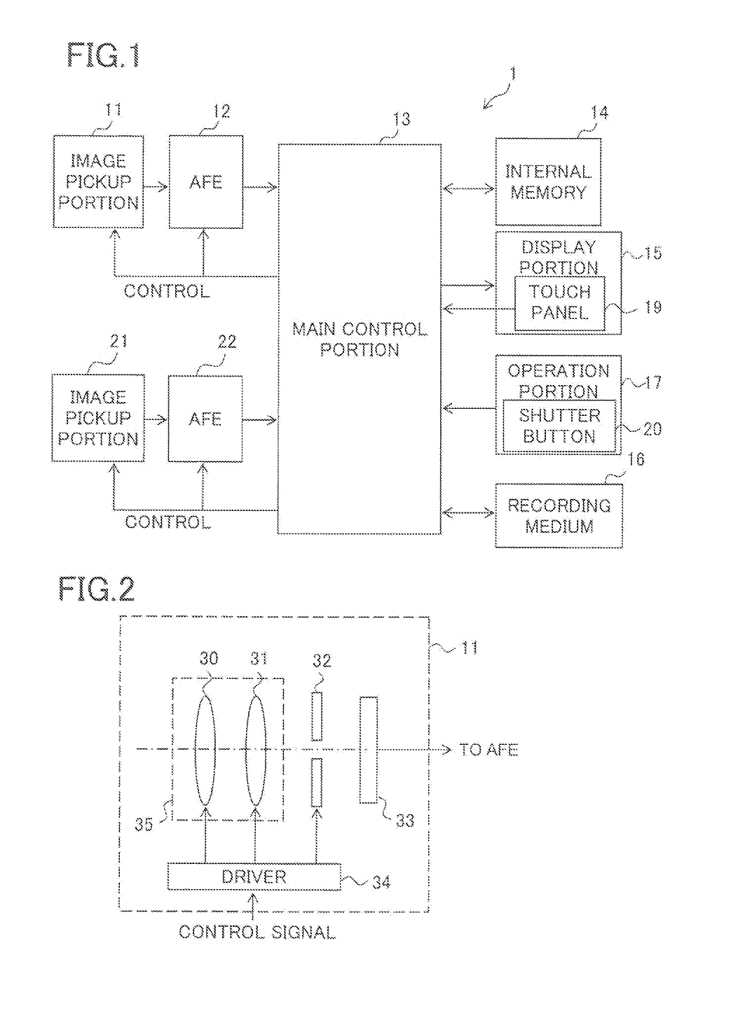

FIG. 1 is a schematic general block diagram of an image pickup apparatus 1 according to an embodiment of the present invention. The image pickup apparatus 1 is a digital still camera capable of taking and recording still images or a digital video camera capable of taking and recording still images and moving images.

The image pickup apparatus 1 includes an image pickup portion 11 as a first image pickup portion, an analog front end (AFE) 12, a main control portion 13, an internal memory 14, a display portion 15, a recording medium 16, an operation portion 17, an image pickup portion 21 as a second image pickup portion, and an AFE 22.

FIG. 2 illustrates an internal structural diagram of the image pickup portion 11. The image pickup portion 11 includes an optical system 35, an aperture stop 32, an image sensor 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 and a focus lens 31. The zoom lens 30 and the focus lens 31 can move in an optical axis direction. The driver 34 drives and controls positions of the zoom lens 30 and the focus lens 31 as well as an opening degree of the aperture stop 32 based on a control signal from the main control portion 13, so as to control a focal length (angle of view) and a focal position of the image pickup portion 11 and incident light intensity to the image sensor 33 (i.e., an aperture stop value).

The image sensor 33 performs photoelectric conversion of an optical image of a subject that enters the image sensor 33 through the optical system 35 and the aperture stop 32, and the image sensor 33 outputs an electric signal obtained by the photoelectric conversion to the AFE 12. More specifically, the image sensor 33 includes a plurality of light receiving pixels arranged in matrix in a two-dimensional manner. When an image is photographed; each of the light receiving pixels accumulates a signal charge whose amount corresponds to exposure time. An analog signal having amplitude proportional to the charge amount of the accumulated signal charge is output from each light receiving pixel and is sequentially delivered to the AFE 12 in accordance with a drive pulse generated inside the image pickup apparatus 1.

The AFE 12 amplifies the analog signal delivered from image pickup portion 11 (image sensor 33 in the image pickup portion 11) and converts the amplified analog signal into a digital signal. The AFE 12 delivers this digital signal as a first RAW data to the main control portion 13. An amplification degree of the signal amplification in the AFE 12 is controlled by the main control portion 13.

It is possible to constitute the image pickup portion 21 to have the same structure as the image pickup portion 11, and The main control portion 13 may control the image pickup portion 21 in the same manner as the image pickup portion 11.

The AFE 22 amplifies the analog signal delivered from the image pickup portion 21 (image sensor 33 in the image pickup portion 21) and converts the amplified analog signal into a digital signal. The AFE 22 delivers this digital signal as a second RAW data to the main control portion 13. An amplification degree of the signal amplification in the AFE 22 is controlled by the main control portion 13.

The main control portion 13 is constituted of &central processing unit (CPU), a read only memory (ROM), a random access memory (RAM), and the like. The main control portion 13 generates image data indicating an image photographed by the image pickup portion 11 based on the first RAW data from the AFE 12. The main control portion 13 also generates image data indicating an image photographed by the image pickup portion 21 based on the second RAW data from the AFE 22. Here, the generated image data includes a luminance signal and a color difference signal, for example. However, the first or the second RAW data itself is one type of the image data, and the analog signal delivered from the image pickup portion 11 or 21 is also one type of the image data. In addition, the main control portion 13 also has a function as a display control portion for controlling display content of the display portion 15, and the main control portion 13 performs control necessary for display on the display portion 15.

The internal memory 14 is constituted of a synchronous dynamic random access memory (SDRAM) or the like and temporarily stores various data generated in the image pickup apparatus 1. The display portion 15 is a display device having a display screen of a liquid crystal display panel or the like and displays the photographed image, an image recorded in the recording medium 16 or the like, under control of the main control portion 13.

The display portion 15 is provided with a touch panel 19, and a user as a photographer can give various instructions to the image, pickup apparatus 1 by touching a display screen of the display portion 15 with a touching object (such as a finger). However, it is also possible to eliminate the touch panel 19 from the display portion 15.

The recording medium 16 is a nonvolatile memory such as a card semiconductor memory or a magnetic disk and stores image data and the like under control of the main control portion 13. The operation portion 17 includes a shutter button 20 or the like that receives instruction to photograph a still image, and the operation portion 17 receives various operations. Contents of an operation to the operation portion 17 is given to the main control portion 13.

Action modes of the image pickup apparatus 1 include a photographing mode in which a still image or a moving image can be photographed and a reproducing mode in which a still image or a moving image recorded in the recording medium 16 can be reproduced on the display portion 15. In the photographing mode, the image pickup portions 11 and 21 take images of a subject periodically at a predetermined frame period, so that the image pickup portion 11 (more specifically, the AFE 12) delivers first RAW data indicating a photographed image sequence of the subject, and that the image pickup portion 21 (more specifically, the AFE 22) delivers second RAW data indicating a photographed image sequence of the subject. The image sequence such as the photographed image sequence means a set of images arranged in time series. Image data of one frame period expresses one image. One photographed image expressed by the first RAW data of one frame period or one photographed image expressed by the second RAW data of one frame period is also called an input image. It is also possible to interpret that the input image is an image obtained by performing a predetermined image processing (a demosaicing process, a noise reduction process, a color correction process, or the like) on a photographed ‘image’ based on the first or the second RAW data An input image based on the first RAW data is particularly referred to as a first input image, and an input image based on the second RAW data is particularly referred tows a second input image. Note that in this specification, image data of an arbitrary image may be simply referred to as an image. Therefore, for example, an expression of recording an input image has the same meaning as an expression of recording image data of an input image.

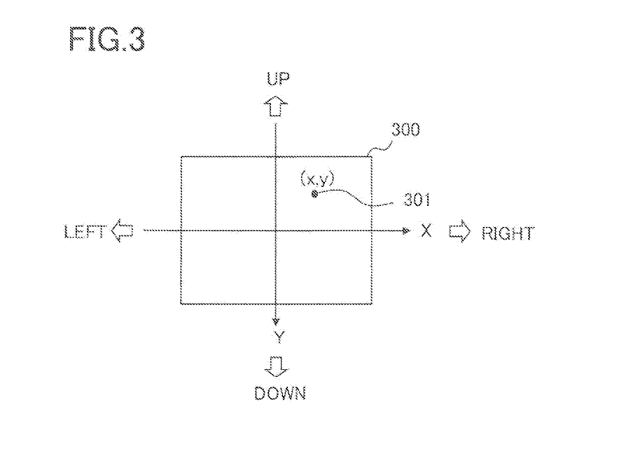

FIG. 3 illustrates a two-dimensional image space XY. The image space XY is a two-dimensional coordinate system having an X axis and a Y axis as coordinate axes on a spatial domain. An arbitrary two-dimensional image 300 can be considered as an image disposed on the image space XY. The X axis and the Y axis are axes along the horizontal direction and the vertical direction of the two-dimensional image 300, respectively. The two-dimensional image 300 is constituted of a plurality of pixels arranged in matrix in the horizontal direction and the vertical direction, and a position of any pixel 301 on the two-dimensional image 300 is expressed by (x, y). In this specification, a position of a pixel is also referred to simply as a pixel position. The reference symbols x and y denote coordinate values of the pixel 301 in the X axis and Y axis directions, respectively. In the two-dimensional coordinate system XY, when a position of a pixel moves right by one pixel, the coordinate value of the pixel in the X axis direction increases by one. When a position of a pixel to the lower side by one pixel, the coordinate value of the pixel in the Y axis direction increases by one. Therefore, if a position of the pixel 301 is (x, y), positions of right, left, lower, and upper adjacent pixels to the pixel 301 are expressed by (x+1, y), (x−1, y), (x, y+1), and (x, y−1), respectively.

There is one or more subjects in photographing ranges of the image pickup portions 11 and 21. All the subjects included in the photographing ranges of the image pickup portions 11 and 21 are generically referred to as a subject group. The subject in the following description means a subject included in the subject group unless otherwise noted.

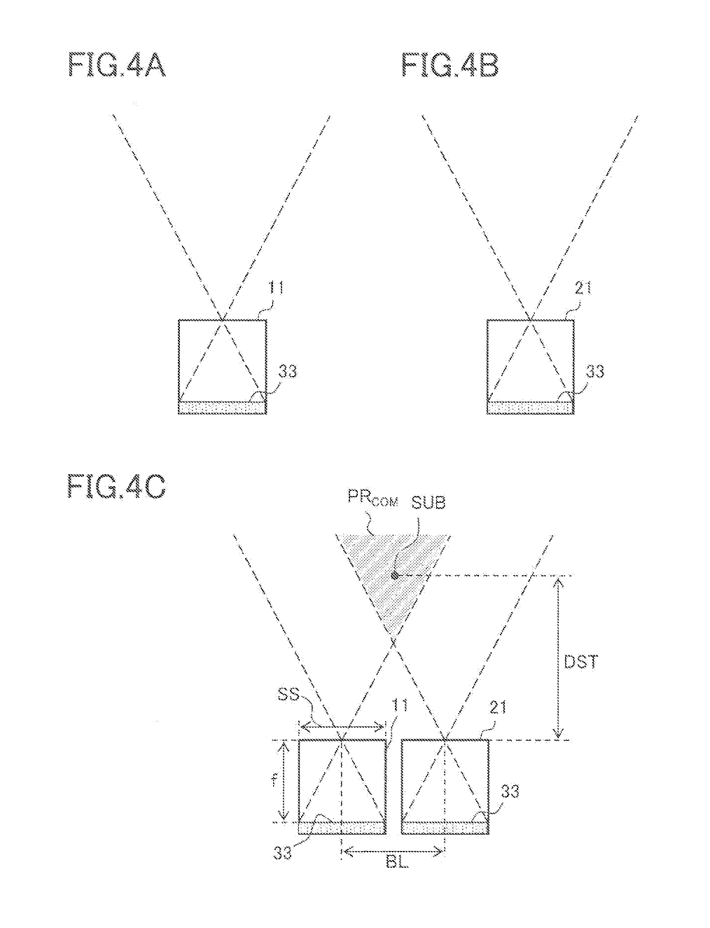

FIGS. 4A and 4B respectively illustrate a photographing range of the image pickup portion 11 and a photographing range of the image pickup portion 21. FIG. 4C illustrates a relationship between the photographing range of the image pickup portion 11 and the photographing range of the image pickup portion 21. In FIG. 4A, a region defined by oblique lines extending from the image pickup portion 11 indicates the photographing range of the image pickup portion 11. In FIG. 4B, a region defined by oblique lines extending from the image pickup portion 21 indicates the photographing range of the image pickup portion 21. There is a common photographing range between the photographing range of the image pickup portion 11 and the photographing range of the image pickup portion 21. In FIG. 4C, the range PR_{COM} with hatching indicates the common photographing range. The common photographing range is an overlapping range of the photographing ranges of the image pickup portion 11 and the image pickup portion 21. A part of the photographing range of the image pickup portion 11 and a part of the photographing range of the image pickup portion 21 forms the common photographing range. In the photographing ranges of the image pickup portions 11 and 21, the ranges outside the common photographing range are referred to as non-common photographing ranges.

There is parallax between the image pickup portions 11 and 21. In other words, a visual point of the first input image and a visual point of the second input image are different from each other. A position of the image sensor 33 of the image pickup portion 11 can be considered to correspond to the visual point of the first input image, and a position of the image sensor 33 of the image pickup portion 21 can be considered to correspond to the visual point of the second input image.

In FIG. 4C, the reference symbol f denotes a focal length of the image pickup portion 11, and the reference symbol SS denotes a sensor size of the image sensor 33 of the image pickup portion 11. It is possible that the image pickup portions 11 and 21 have different focal lengths f and different sensor sizes. SS, but it is supposed here that the image pickup portions 11 and 21 have the same focal length f and the same sensor size SS unless otherwise noted. In FIG. 4C, the reference symbol BL denotes a length of a baseline between the image pickup portions 11 and 21. The baseline between the image pickup portions 11 and 21 is a line segment connecting the center of the image sensor 33 of the image pickup portion 11 and the center of the image sensor 33 of the image pickup portion 21.

In FIG. 4C, the reference symbol SUB denotes an arbitrary subject included in the subject group. The subject SUB is within the common photographing range in FIG. 4C, but the subject SUB can be positioned within the non-common photographing range. The reference symbol DST denotes a subject distance of the subject SUB. The subject distance of the subject SUB means a distance between the subject SUB and the image pickup apparatus 1 in the real space, and the subject distance of the subject SUB is identical to a distance between the subject SUB and the optical center of the image pickup portion 11 (principal point of the optical system 35) as well as a distance between the subject SUB and the optical center of the image pickup portion 21 (principal point of the optical system 35).

The main control portion 13 can detect the subject distance from the first and second input images using the triangulation principle based on the parallax between the image pickup portions 11 and 21. Images 310 and 320 illustrated in FIGS. 5A and 5B are examples of the first and second input images obtained by photographing the subject SUB simultaneously. Here, for convenience of description, it is supposed that the subject SUB is a point light source having no width and no thickness. In FIG. 5A, a point image 311 is an image of the subject SUB included in the first input image 310. In FIG. 5B, a point image 321 is an image of the subject SUB included in the second input image 320. As illustrated in FIG. 5C, the first input image 310 and the second input image 320 are placed on the same image space XY for consideration, and a distance d between the position of the point image 311 on the first input image 310 and the position of the point image 321 on the second input image 320 is determined. The distance d is a distance on the image space XY. If the distance d is determined, a subject distance DST of the subject SUB can be determined in accordance with the following equation (1).

DST=BL×f/d (1)

A set of the first and second input images photographed simultaneously is referred to as a stereo image. The main control portion 13 can perform a process of detecting a subject distance of each subject based on the stereo image in accordance with the equation (1) (hereinafter referred to as a first distance detecting process). A detection result of each subject distance by the first distance detecting process is referred to as a first distance detection result.

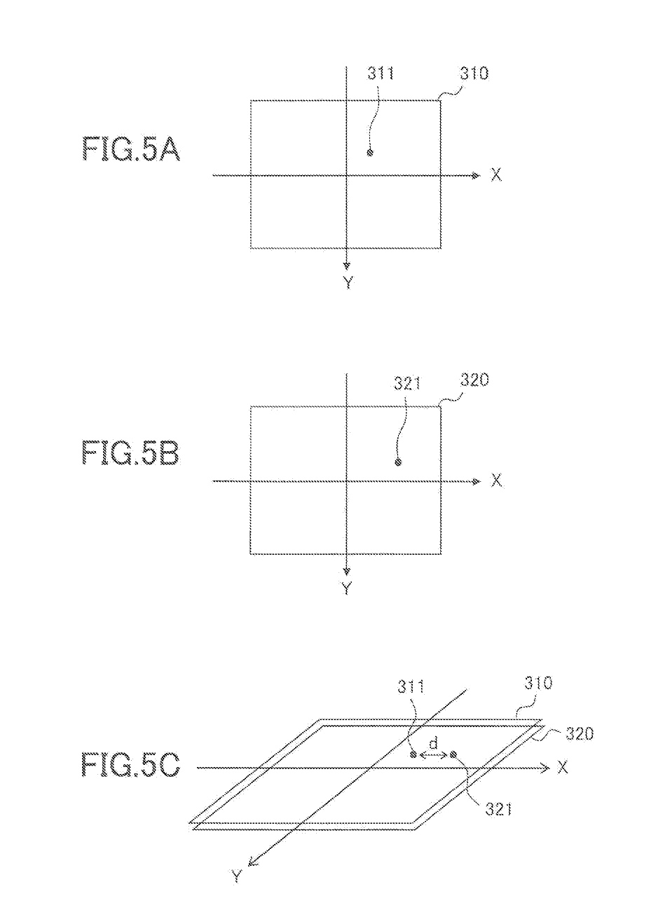

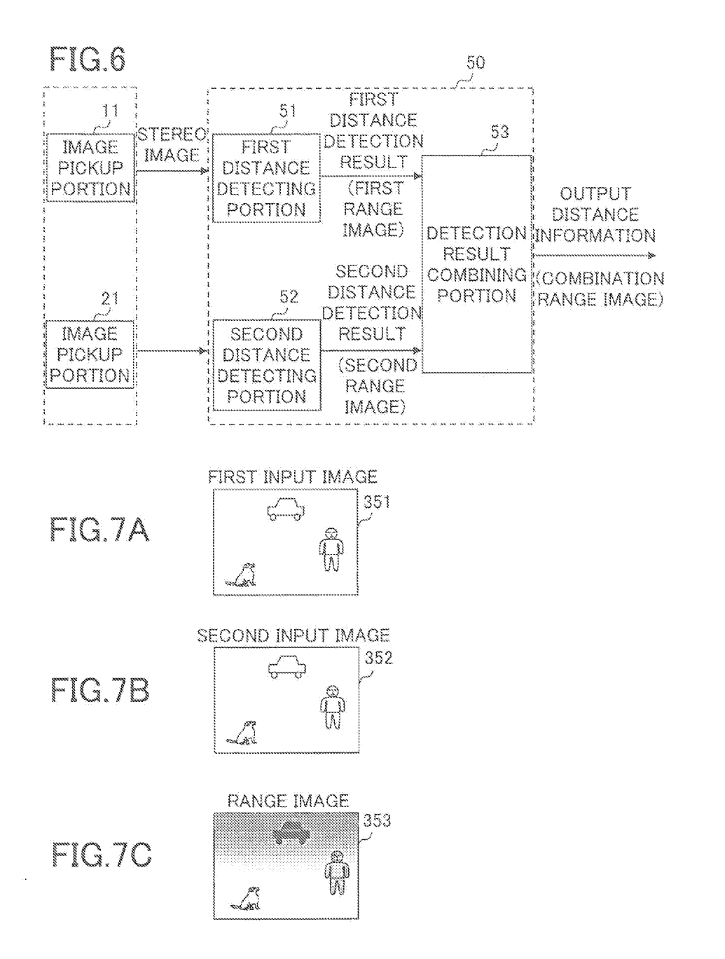

FIG. 6 illustrates an internal block diagram of a distance information generating portion 50 that can be disposed in the main control portion 13. The distance information generating portion 50 includes a first distance detecting portion 51 (hereinafter may be referred to simply as a detecting portion 51) that outputs the first distance detection result by performing the first distance detecting process based on the stereo image, a second distance detecting portion 52 (hereinafter may be referred to simply as a detecting portion 52) that outputs a second distance detection result by performing a second distance detecting process different from the first distance detecting process, and a detection result combining portion 53 (hereinafter may be referred to simply as a combining portion 53) that combines the first and second distance detection results so as to generate an output distance information. In the first distance detecting process, the first distance detection result is generated from the stereo image by the stereovision method. In the second distance detecting process, each subject distance is detected by a detection method different from the detection method of a subject distance used in the first distance detecting process (details will be described later). The second distance detection result is a detection result of each subject distance by the second distance detecting process.

The output distance information that is to be called as a combination distance detection result is information for specifying a subject distance of each subject on the image space XY, and in other words, information for specifying a subject distance of a subject at each pixel position on the image space XY. The output distance information indicates a subject distance of a subject at each pixel position of the first input image or a subject distance of a subject at each pixel position of the second input image. A form of the output distance information may be arbitrary, but here, it is supposed that the output distance information is a range image (in other words, a distance image). The range image is a gray-scale image in which each pixel has a pixel value corresponding to a measured value of the subject distance (i.e., a detected value of the subject distance). Images 351 and 352 illustrated in FIGS. 7A and 7B are examples of the first and second input images that are simultaneously photographed, and an image 353 illustrated in FIG. 7C is an example of the range image based on the images 351 and 352. Note that forms of the first and second distance detection results are also arbitrary, but here, it is supposed that they are also expressed in a form of the range image. The range images expressing the first and the second distance detection results are referred to as a first and a second range image, respectively, and the range image expressing the output distance information is referred to as a combination range image (or output range image) (see FIG. 6).

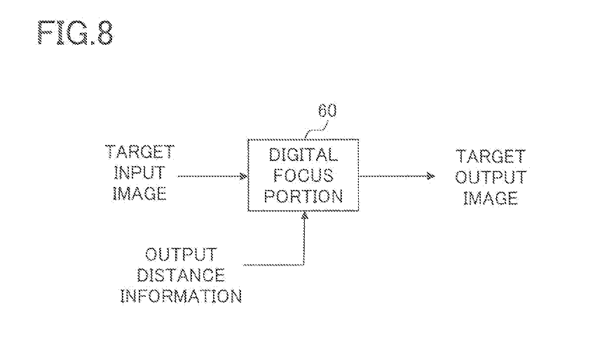

The main control portion 13 can use the output distance information for various applications. For instance, the main control portion 13 may be provided with a digital focus portion 60 illustrated in FIG. 8. The digital focus portion 60 may also referred to as a focused state changing portion or a focused state adjusting portion. The digital focus portion 60 performs image processing for changing a focused state of a target input image (i.e., image processing for adjusting a focused state of the target input image) using the output distance information. This image processing is referred to as digital focus. The target input image is the first or the second input image. The target input image after changing the focused state is referred to as a target output image. The digital focus enables to generate a target output image having an arbitrary focused distance and an arbitrary depth of field from the target input image. As an image processing method for generating a target output image from a target input image, arbitrary image processing methods including known image processing methods can be used. For instance, a method disclosed in JP-A-2009-224982 or JP-A-2010-81002 can be used.

The subject distances of many subjects can be detected accurately by the first distance detecting process based on the stereo image. However, the first distance detecting process cannot detect the subject distance of a subject positioned in the non-common photographing range as a principle. In other words, the subject distance of a subject that exists only in one of the first and second input images cannot be detected. In addition, the first distance detecting process may not detect the subject distance accurately for some subjects by a certain circumstance.

Considering these circumstances, the distance information generating portion 50 utilizes the second distance detecting process in addition to the first distance detecting process and uses the first and second distance detection results to generate the output distance information. For instance, the distance information generating portion 50 performs interpolation of the first distance detection result using the second distance detection result so that the distance information can be obtained also for the subject positioned in the non-common photographing range. Alternatively, for example, the distance information generating portion 50 uses the second distance, detection result for a subject for which the subject distance cannot be detected accurately by the first distance detecting process.

Thus, it is possible to perform interpolation of the subject distance that cannot be detected by the first distance detecting process or the subject distance that cannot be detected with high accuracy by the first distance detecting process by using the second distance detection result. Thus, it is possible to enlarge the range in which the subject distance can be detected as a whole. If the obtained output distance information is used for the digital focus, the focused state adjustment can be performed for the entire or most part of the target input image.

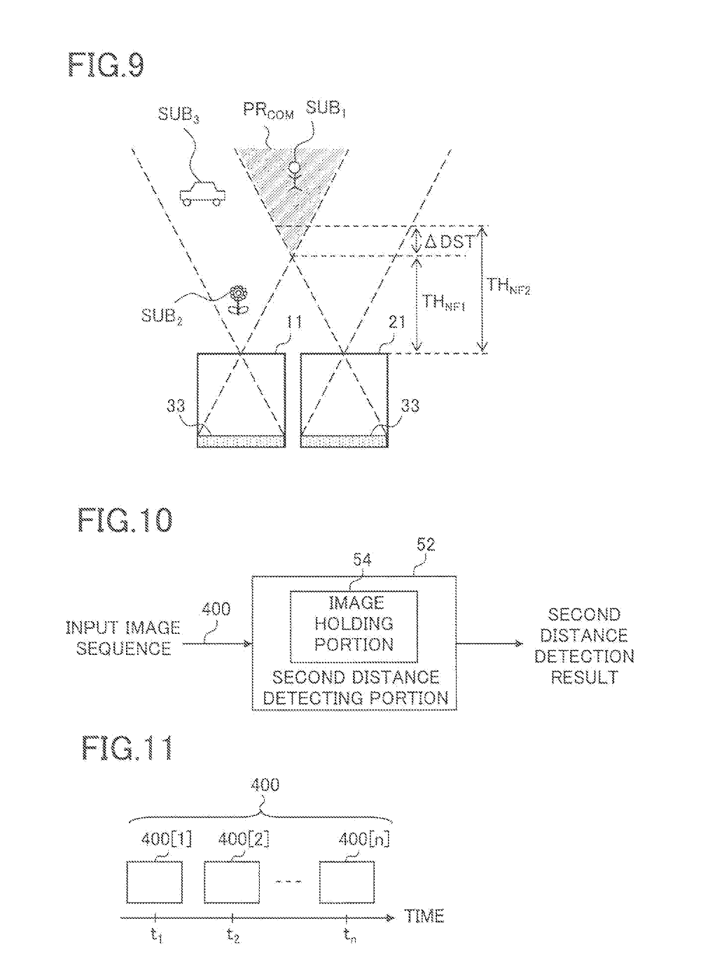

Prior to describing a specific method of generating the output distance information, some terms are defined with reference to FIG. 9. Subjects positioned in the non-common photographing range include subjects SUB₂ and SUB₃ as illustrated in FIG. 9. The subject SUB₂ is positioned in the non-common photographing range because a distance between the subject SUB₂ and the image pickup apparatus 1 is too short. The subject SUB₃ is positioned at an end of the photographing range of the image pickup portion 11 or 21, which is an end opposite to the common photographing range. The subject SUB₃ is referred to as an end subject.

As illustrated in FIG. 9, a minimum subject distance among subject distances belonging to the common photographing range PR_{COM} is referred to as a distance TH_{NF1}. Further, a distance (TH_{NF1}+ΔDST) is referred to as a distance TH_{NF2}. A value ΔDST is zero or larger. A value of ΔDST can be determined in advance based on characteristics of the first distance detecting process. The value of ΔDST may be zero, and in this case, TH_{NF1} is equal to TH_{NF2}.

A subject having a subject distance of the distance TH_{NF2} or larger among subjects positioned in the common photographing range are referred to as a normal subject. The subject SUB₁ illustrated in FIG. 9 is one type of the normal subject. If ΔDST is zero, all subjects positioned in the common photographing range are normal subjects. On the other hand, a subject having a subject distance smaller than the distance TH_{NF2} is referred to as a near subject. The subject SUB₂ in FIG. 9 is one type of the near subject. If ΔDST is larger than zero, subjects positioned within the common photographing range also belongs to the near subject. The end subject has a subject distance of the distance TH_{NF2} or larger among the subjects positioned within the non-common photographing range.

Hereinafter, first to sixth embodiments will be described as embodiments related to generation of the output distance information or the like.

### First Embodiment

The first embodiment of the present invention will be described. In the first embodiment, as illustrated in FIG. 10, an image holding portion 54 is disposed in the detecting portion 52. The detecting portion 52 performs the second distance detecting process based on an input image sequence 400. Note that it is possible to consider that the image holding portion 54 is disposed outside the detecting portion 52. In addition, the image holding portion 54 may be disposed in the internal memory 14 illustrated in FIG. 1. The method of the second distance detecting process based on the input image sequence 400 described in the first embodiment is referred to as a detection method A1, for convenience sake. The combining portion 53 illustrated in FIG. 6 generates the output distance information by combining the first and second distance detection results by a combining method B1.

The input image sequence 400 indicates a set of a plurality of first input images arranged in time series, or a set of a plurality of second input images arranged in time series. As illustrated in FIG. 11, the input image sequence 400 consists of n input images 400[1] to 400[n]. In other words, the input image sequence 400 consists of an input image 400[1] photographed at time point t₁, an input image 400[2] photographed at time point t₂, . . . , and an input image 400[n] photographed at time point tₙ. The time point tᵢ₊₁ is after the time point tᵢ (i denotes an integer). A time interval between the time point tᵢ and the time point tᵢ₊₁ is the same as the frame period of the first input image sequence and the frame period of the second input image sequence. Alternatively, the time interval between the time point tᵢ and the time point tᵢ₊₁ is the same as an integral multiple of the frame period of the first input image sequence and an integral multiple of the frame period of the second input image sequence. The symbol n denotes an arbitrary integer of 2 or larger. Here, for specific description, it is supposed that the input images 400[1] to 400[n] are the input images and that n is two.

The image holding portion 54 holds the image data of the input images 400[1] to 400[n−1] until the image data of the input image 400[n] is supplied to the detecting portion 52. If n is two as described above, the image data of the input image 400[1] is held by the image holding portion 54.

The detecting portion 52 detects each subject distance by using structure from motion (SFM) based on the image data held by the image holding portion 54 and the image data of the input image 400[n], namely, based on the image data of the input image sequence 400. The SFM is also referred to as “estimation of structure from motion”. Because the detection method of the subject distance using the SFM is known, detailed description of the method is omitted. The detecting portion 52 can utilize a known detection method of the subject distance using the SFM (for example, a method described in JP-A-2000-3446). If the image pickup apparatus 1 is moving in the period while the input image sequence 400 is photographed, the subject distance can be estimated by the SFM. The movement of the image pickup apparatus 1 is caused, for example, by a shake of the image pickup apparatus 1 (a method corresponding to a case without a shake will be described later in a fifth embodiment).

In the SFM, it is necessary to estimate the motion of the image pickup apparatus 1 for estimating the distance. Therefore, detection accuracy of the subject distance by the SFM is basically lower than detection accuracy of the subject distance based on the stereo image. On the other hand, in the first distance detecting process based on the stereo image, it is difficult to detect the subject distances of the near subject and the end subject as described above.

Therefore, the combining portion 53 generates output distance information using the first distance detection result as a rule, but generates the output distance information using the second distance detection result for subject distances of the near subject and the end subject. In other words, the combining portion 53 combines the first and second distance detection results so that the first distance detection result concerning the subject distance of the normal subject is included in the output distance information (in other words, incorporated into the output distance information) and that the second distance detection result concerning the subject distances of the near subject and the end subject are included in the output distance information (in other words, incorporated into the output distance information). In the first embodiment, the distance ΔDST illustrated in FIG. 9 may be zero or may be larger than zero.

More specifically, for example, if the subject corresponding to the pixel position (x, y) in the combination range image is the normal subject, a pixel value VAL₁(x, y) at the pixel position (x, y) in the first range image is written at the pixel position (x, y) in the combination range image. If the subject corresponding to the pixel position (x, y) in the combination range image is the near subject or the end subject, a pixel value VAL₂(x, y) at the pixel position (x, y) in the second range image is written at the pixel position (x, y) in the combination range image. From the pixel values VAL₁(x, y) and VAL₂(x, y), it is possible to decide whether the subject corresponding to the pixel position (x, y) in the combination range image is the normal subject or one of the near subject and the end subject (the same is true in the other embodiments described later).

For instance, if the distance ΔDST in FIG. 9 is zero, the following process (hereinafter referred to as a process J1) can be performed.

If the subject corresponding to the pixel position (x, y) in the combination range image is the normal subject, the first distance detecting process can detect the subject distance corresponding to the pixel position (x, y). As a result, the pixel value VAL₁(x, y) is a valid value. On the other hand, if the subject corresponding to the pixel position (x, y) in the combination range image is the near subject or the end subject, the first distance detecting process cannot detect the subject distance corresponding to the pixel position (x, y). As a result, the pixel value VAL₁(x, y) is an invalid value. Therefore, in the process J1, if the pixel value VAL₁(x, y) is a valid value, the pixel value: VAL₁(x, y) is written in the pixel, position (x, y) in the combination range image. If the pixel value VAL₁(x, y) is an invalid value, the pixel value VAL₂(x, y) is written in the pixel position (x, y) in the combination range image. This writing process is performed sequentially for all pixel positions, and thus the entire image of the combination range image is formed. Note that it is also possible to use a method in which the pixel value VAL₁(x, y) does not have an invalid value (see an eighth application technique described later).

### Second Embodiment

A second embodiment of the present invention will be described. A method of the second distance detecting process described in the second embodiment is referred to as a detection method A2. A method described in the second embodiment for generating the output distance information from the first and second distance detection results is referred to as a combining method B2.

In the second embodiment, an image sensor 33_{A} is used for each of the image sensor 33 of the image pickup portion 11 and the image sensor 33 of the image pickup portion 21. However, it is possible that only one of the image sensors 33 of the image pickup portions 11 and 21 is the image sensor 33_{A}. The image sensor 33_{A} is an image sensor that can realize so-called image plane phase difference AF.

As described above about the image sensor 33, the image sensor 33_{A} is also constituted of a CCD, a CMOS image sensor, or the like. However, the image sensor 33_{A} is provided with, in addition to third light receiving pixels which are light receiving pixels for imaging, phase difference pixels for detecting the subject distance. The phase difference pixels are constituted of a pair of first and second light receiving pixels disposed close to each other. There are plurality of first, second, and third light receiving pixels, each. A plurality of first light receiving pixels, a plurality of second light receiving pixels and a plurality of third light receiving pixels are referred to as a first light receiving pixel group, a second light receiving pixel group, and a third light receiving pixel group, respectively. Pairs of first and second light receiving pixels can be disposed and distributed over the entire imaging surface of the image sensor 33_{A} at a constant interval.

In the image sensor other than the image sensor 33_{A}, only the third light receiving pixels are usually arranged in matrix. The image sensor in which only the third light receiving pixels are arranged in matrix is regarded as a reference, and a part of the third light receiving pixels are replaced by the phase difference pixels. Then, the image sensor 33_{A} is formed. As a method of forming the image sensor 33_{A} and a method of detecting the subject distance from output signals of the phase difference pixels, it is possible to use known methods (for example, a method described in JP-A-2010-117680).

For instance, an imaging optical system and the image sensor 33_{A} are formed so that only light passing through a first exit pupil region of the imaging optical system is received by the first light receiving pixel group, and that only light passing through a second exit pupil region of the imaging optical system is received by the second light receiving pixel group, and that light passing through a third exit pupil region including the first and second exit pupil regions of the imaging optical system is received by the third light receiving pixel group. The imaging optical system means a bulk including the optical system 35 and the aperture stop 32 corresponding to the image sensor 33_{A}. The first and second exit pupil regions are exit pupil regions that are different from each other and are included in the entire exit pupil region of the imaging optical system. The third exit pupil region may be the same as the entire exit pupil region of the imaging optical system.

The input image is a subject image formed by the third light receiving pixel group. In other words, image data of the input image is generated from an output signal of the third light receiving pixel group. For instance, image data of the first input image is generated from the output signal of the third light receiving pixel group of the image sensor 33_{A} disposed in the image pickup portion 11. However, output signals of the first and second light receiving pixel groups may be related to image data of the input image. On the other hand, the subject image formed by the first light receiving pixel group is referred to as an image AA, and the subject image formed by the second light receiving pixel group is referred to as an image BB. The image data of the image AA is generated from the output signal of the first light receiving pixel group, and the image data of the image BB is generated from the output signal of the second light receiving pixel group. The main control portion 13 illustrated in FIG. 1 can realize so-called automatic focus (AF) by detecting relative position displacement between the image AA and the image BB. On the other hand, the detecting portion 52 can detect the subject distance of the subject at each pixel position in the input image based on information indicating characteristics of the imaging optical system and image data of the image AA and the image BB.

There is a parallax between the first light receiving pixel group and the second light receiving pixel group. Similarly to the first distance detecting process, also in the second distance detecting process using the output of the image sensor 33_{A}, the subject distance is detected using the triangulation principle from the two images (AA and BB) photographed simultaneously. However, the length of the baseline between the first light receiving pixel group for generating the image AA and the second light receiving pixel group for generating the image BB is shorter than the length BL of the baseline illustrated in FIG. 4C. In the distance detection using the triangulation principle, detection accuracy is improved for a relatively small subject distance by decreasing the length of the baseline, while detection accuracy is improved for a relatively large subject distance by increasing the length of the baseline. Therefore, detection accuracy of the subject distance is improved more by using the second distance detecting process for the near subject.

Therefore, the combining portion 53 generates the output distance information using the first distance detection result for a relatively large subject distance and generates the output distance information using the second distance detection result for a relatively small subject distance. In other words, the combining portion 53 combines the first and second distance detection results so that the first distance detection result of the subject distance of the normal subject is included in the output distance information (in other words, incorporated into the output distance information) and that the second distance detection result of the subject distance of the near subject is included in the output distance information (in other words, incorporated into the output distance information). Note that it is preferred that the second distance detection result is included in the output distance information for the subject distance of the end subject. In the second embodiment too, the distance ΔDST illustrated in FIG. 9 may be zero or may be larger than zero.

More specifically, for example, if the subject corresponding to the pixel position (x, y) in the combination range image is the normal subject, the pixel value VAL₁(x, y) at the pixel position (x, y) in the first range image is written in the pixel position (x, y) in the combination range image. If the subject corresponding to the pixel position (x, y) in the combination range image is the near subject, the pixel value VAL₂(x, y) at the pixel position (x, y) in the second range image is written in the pixel position (x, y) in the combination range image.

In other words, for example, the following process (hereinafter referred to as a process J2) can be performed.

In the process J2, if the subject distance indicated by the pixel value VAL₁(x, y) is the distance TH_{NF2} or larger, the pixel value VAL₁(x, y) is written at the pixel position (x, y) in the combination range image. If the subject distance indicated by the pixel value VAL₁(x, y) is smaller than the distance TH_{NF2}, the pixel value VAL₂(x, y) is written at the pixel position (x, y) in the combination range image. This writing process is performed sequentially for all pixel positions, and thus the entire image of the combination range image is formed.

### Third Embodiment

A third embodiment of the present invention will be described. A method of the second distance detecting process described in the third embodiment is referred to as a detection method A3. A method described in the third embodiment for generating the output distance information from the first and second distance detection results is referred to as a combining method B3.

In the third embodiment, the detecting portion 52 generates the second distance detection result from one input image 420 as illustrated in FIG. 12. The input image 420 is one first input image photographed by the image pickup portion 11 or one second input image photographed by the image pickup portion 21.

As a method for generating the second distance detection result (second range image) from one input image 420, a known arbitrary distance estimation method can be used. For instance, there are an available distance estimation method described in Non-patent document, Takano and other three persons, “Depth Estimation from a Single Image using an Image Structure”, ITE Technical Report, July, 2009, Vol. 33, No.31, pp 13-16 and an available distance estimation method described in Non-patent document, Ashutosh Saxena and other two persons, “3-D Depth Reconstruction from a Single Still Image”, Springer Science+Business Media, 2007, Int J Comput Vis, DOI 1007/S11263-007-0071-y.

Alternatively, for example, it is also possible to generate the second distance detection result from an edge state of the input image 420. More specifically, for example, a pixel position where a focused subject exists is specified as a focused position from spatial frequency components contained in the input image 420, and the subject distance corresponding to the focused position is determined from characteristics of the optical system 35 when the input image 420 is photographed. After that, a degree of blur (edge gradient) of the image at other pixel position is evaluated, and the subject distance at the other pixel position can be determined from the degree of blur with reference to the subject distance corresponding to the focused position.

The combining portion 53 evaluates reliability of the first distance detection result and reliability of the second distance detection result, so as to use the distance detection result of higher reliability for generating the output distance information. The reliability evaluation of the first distance detection result can be performed for each subject (namely, for each pixel position).

A method of calculating reliability R₁ of the first distance detection result will be described. If the distance d (see FIG. 5C) determined for the subject SUB (see FIG. 4C) is d_{O} and stereo matching similarity for the subject SUB is SIM_{O}, the reliability R₁ of the subject distance detection of the subject SUB by the first distance detecting process is expressed by the following equation (2). Symbols k₁ and k₂ are preset positive coefficients. Here, at least one of k₁ and k₂ may be zero. In addition, the sensor size SS in the equation (2) indicates a length of one side of the image sensor 33 having a rectangular shape.

R₁=k₁×d_{O}/SS+k₂×SIM_{O} (2)

The evaluation of reliability R₂ of the second distance detection result can also be performed for each subject (namely, for each pixel position).

The combing portion 53 compares the reliability values R₁ and R₂ for each subject (namely, for each pixel position). Then, for the subject having the corresponding reliability R₁ higher than the reliability R₂, the combining portion 53 uses the first distance detection result to generate the output distance information. For the subject having the corresponding reliability R₂ higher than the reliability R₁, the combining portion 53 uses the second distance detection result to generate the output distance information.

Alternatively, the combining portion 53 can also generate the combination range image based on the reliability R₁ of the first distance detection result without evaluating the reliability R₂ of the second distance detection result. In this case, it is preferred to use the first range image to generate the combination range image for the part having high reliability R₁ and to use the second range image to generate the combination range image for the part having low reliability R₂.

In other words, for example, the following process (hereinafter referred to as process J3) can be performed.

In process J3, the reliability R₁ for the pixel position (x, y) is compared with a predetermined reference value R_{REF}. If the reliability R₁ is the reference value R_{REF} or larger, the pixel value VAL₁(x, y) of the first range image is written at the pixel position (x, y) in the combination range image. If the reliability R₁ is smaller than the reference value R_{REF}, the pixel value VAL₂(x, y) of the second range image is written at the pixel position (x, y) in the combination range image. By performing this writing process sequentially for all pixel positions, the entire image of the combination range image is formed.

In order to describe the meaning of the similarity SIM_{O} in the equation (2), the first distance detecting process based on the images 351 and 352 is further described (see FIGS. 7A and 7B). In the first distance detecting process, one of the images 351 and 352 is set as a reference image while the other is set as a non-reference image. Then, the pixel corresponding to a noted pixel on the reference image is searched for in the non-reference image based on image data of the reference image and the non-reference image. This search is also referred to as stereo matching. More specifically, for example, an image within an image region having a predetermined size around the noted pixel as the center is extracted as a template image from the reference image, and similarity between the template image and an image within an evaluation region set in the non-reference image is determined. A position of the evaluation region set in the non-reference image is shifted one by one, and the similarity is calculated at each shift. Then, among a plurality of obtained similarity values, a maximum similarity is specified, and it is decided that the corresponding pixel of the noted pixel exists at the position corresponding to the maximum similarity. If image data of the subject SUB exists at the above-mentioned noted pixel, the maximum similarity specified here corresponds to the similarity SIM_{O}.

After the corresponding pixel of the noted pixel is specified, the distance d is determined based on a position of the noted pixel on the reference image and a position of the corresponding pixel on the non-reference image (see FIG. 5C), and further the subject distance DST of the subject positioned at the noted pixel can be determined in accordance with the equation (1) described above. In the first distance detecting process, the length BL of the baseline and the focal length (when the images 351 and 352 are photographed are known. The pixels on the reference image are set to the noted pixel one by one. Then, the above-mentioned stereo matching and the calculation of the subject distance DST according to the equation (1) are performed sequentially. Thus, the subject distance of the subject at each pixel position in the image 351 or 352 can be detected.

### Fourth Embodiment

A fourth embodiment of the present invention will be described. A method of the second distance detecting process described, in the fourth embodiment is referred to as a detection method A4.

Also in the detection method A4 according to the fourth embodiment, similarly to the detection method A1 according to the first embodiment, each subject distance is detected based on the input image sequence 400 illustrated in FIG. 11. In the fourth embodiment, for specific description, it is supposed that the input images 400[1] to 400[n] are the first input images. Further, the focus lens 31 described in the fourth embodiment indicates the focus lens 31 of the image pickup portion 11, and the lens position indicates a position of the focus lens 31.

In the fourth embodiment, the image pickup apparatus 1 performs AF control (automatic focus control) based on a contrast detection method. In order to realize this control, an AF evaluation portion (not shown) disposed in the main control portion 13 calculates an AF score.

In the AF control based on the contrast detection method, the AF score of the image region set within the AF evaluation region is calculated one by one while the lens position is changed sequentially, and the lens position at which the AF score is maximized is searched for as a focused lens position. After the searching, the lens position is fixed to the focused lens position so that the subject positioned within the AF evaluation region can be focused. The AF score of a certain image region increases as contrast of an image in the image region increases.

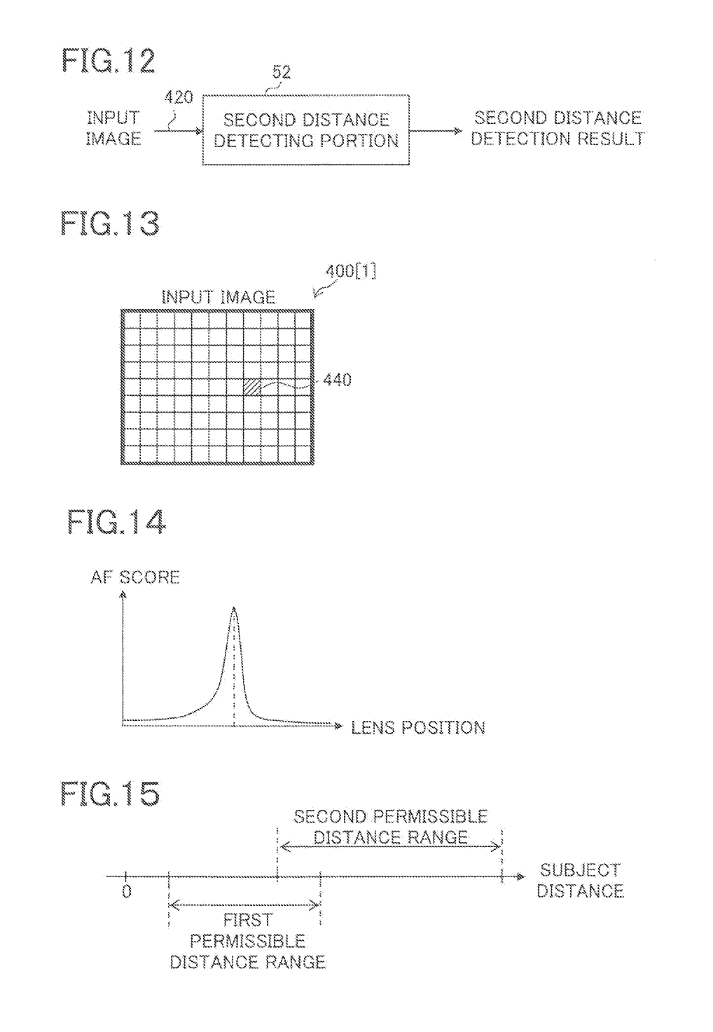

In the execution process of the AF control based on the contrast detection method, the input images 400[1] to 400[n] can be obtained. The AF evaluation portion first attends the input image 400[1] as illustrated in FIG. 13 and splits the entire image region of the input image 400[1] into a plurality of small blocks. Now, among the plurality of small blocks set in the input image 400[1], one small block disposed at a specific position is referred to as a small block 440. The AF evaluation portion extracts a predetermined high frequency component as a relatively high frequency component from spatial frequency components contained in the luminance signal of the small block 440, and accumulates the extracted frequency component so that the AF score of the small block 440 is determined.

The AF score determined for the small block 440 of the input image 400[1 ] is denoted by AF_{SCORE}[1]. The AF evaluation portion sets a plurality of small blocks including the small block 440 also in each of the input images 400[2] to 400[n] similarly to the input image 400[1] and determines the AF score of the small block 440 in each of the input images 400[2] to 400[n]. The AF score determined for the small block 440 of the input image 400[i] is denoted by the AF_{SCORE}[i]. The AF_{SCORE}[i] has a value corresponding to contrast of the small block 440 of the input image 400[i].

The lens positions when the input images 400[1] to 400[n] are photographed are referred to as first to n-th lens positions, respectively. The first to n-th lens positions are different to each other. FIG. 14 illustrates dependency of the AF_{SCORE}[i] on the lens position. The AF_{SCORE}[i] has a maximum value (a local maximum value) at a specific lens position. The detecting portion 52 detects the lens position for the maximum value (a local maximum value) as a peak lens position for the small block 440 and calculates the subject distance of the small block 440 by converting the peak lens position into the subject distance based on characteristics of the image pickup portion 11.

The detecting portion 52 performs the same process as described above also for all small blocks except the small block 440. Thus, the subject distances for all small blocks are calculated. The detecting portion 52 includes (incorporates) the subject distance determined for each small block in the second distance detection result and outputs the same.

The combining method B3 including the process J3 described above in the third embodiment can be used for the fourth embodiment. However, it is also possible to apply the combining method B1 including the process J1 described above in the first embodiment or the combining method B2 including the process J2 described above in the second embodiment to the fourth embodiment.

Similarly, it is also possible to apply the combining method B2 including the process J2 or the combining method B3 including the process J3 to the first embodiment. It is also possible to apply the combining method B1 including the process J1 or the combining method B3 including the process J3 to the second embodiment. Further, it is also possible to apply the combining method B1 including the process J1 or the combining method B2 including the process J2 to the third embodiment.

### Fifth Embodiment

A fifth embodiment of the present invention will be described. In the fifth embodiment, first to eighth application techniques will be described as application techniques that can be applied to the first to fourth embodiments and other embodiments described later. It is supposed that the input image sequence 400 illustrated in FIG. 11 that is referred to in description of each application technique is the first input image sequence. In addition, for specific description, the first to fifth application techniques are described assuming application to the first embodiment, but the first to fifth application techniques can be applied also to any embodiment (except the fifth embodiment) as long as no contradiction arises. The sixth to eighth application techniques can also be applied to an arbitrary embodiment (except the fifth embodiment) as long as no contradiction arises.

—First Application Technique—

Assuming application to the first embodiment, a first application technique will be described. It is supposed that n is two (see FIG. 11). In this case, the first and second input images are simultaneously photographed at the time point t₁, and only the image pickup portion 11 is driven at the time point t₂ so that only the first input image is photographed (namely, the second input image is not photographed at the time point t₂). The first distance detecting process is performed based on the first and second input images at the time point t₁, and the second distance detecting process (second distance detecting process using the SFM) is performed based on the first input images at the time points t₁ and t₂.

It can be said that the second input image at the time point t₂ is unnecessary for generating the output distance information. Therefore, driving of the image pickup portion 21 is stopped at the time point t₂. Thus, power consumption can be reduced.

—Second Application Technique—

Assuming application to the first embodiment, a second application technique will be described. It is supposed that n is two (see FIG. 11). The detecting portion 51 generates the first distance detection result based on the first and second input images photographed simultaneously at the time point t₁, and the detecting portion 52 generates the second distance detection result based on the first input images photographed at the time points t₁ and t₂. The combining portion 53 first refers to the first distance detection result and decides whether or not the first distance detection result satisfies necessary detection accuracy. For instance, if the pixel value indicating the subject distance of the distance TH_{NF2} or larger is given to all pixel positions of the first range image, it is decided that the first distance detection result satisfies the necessary detection accuracy. Otherwise, it is decided that the first distance detection result does not satisfy the necessary detection accuracy.

Then, if the combining portion 53 decides that the first distance detection result satisfies the necessary detection accuracy, the combining portion 53 outputs the first distance detection result itself as the output distance information without using the second distance detection result. If the combining portion 53 decides that the first distance detection result does not satisfy the necessary detection accuracy, the first and second distance detection results are combined as described above.

If the first distance detection result satisfies the necessary detection accuracy, it can be said that the process for the combining is wasteful. According to the second application technique, execution of the wasteful combining process is avoided, so that operating time for obtaining the output distance information can be reduced and that power consumption can be reduced. If the operating time for obtaining the output distance information is reduced, responsiveness of the image pickup apparatus 1 viewed from the user can be improved.

—Third Application Technique—

Assuming application to the first embodiment, a third application technique will be described. It is supposed that n is two (see FIG. 11). The detecting portion 51 generates the first distance detection result based on the first and second input images photographed simultaneously at the time point t₁, and the distance information generating portion 50 or the combining portion 53 (see FIG. 6) decides necessity of the second distance detection result from this first distance detection result. Then, if it is decided that the second distance detection result is necessary, photographing operation is performed for obtaining the first and second input images (or only the first input image) at the time point t₂. On the other hand, if it is decided that the second distance detection result is unnecessary, the photographing operation for obtaining the first input image at the time point t₂ is not performed. If the first distance detection result does not satisfy the necessary detection accuracy, it is decided that the second distance detection result is necessary. If the first distance detection result satisfies the necessary detection accuracy, it is decided that the second distance detection result is unnecessary. The decision whether or not the first distance detection result satisfies the necessary detection accuracy is the same as that described above in the second application technique.

According to the third application technique, execution of photographing operation that is unnecessary or necessary little is avoided, so that operating time for obtaining the output distance information can be reduced and that power consumption can be reduced.

—Fourth Application Technique—

A fourth application technique will be described. When the detection method A1 using the SFM is performed (see FIGS. 10 and 11), the subject must have a movement in the input image sequence 400. However, in the case where the image pickup apparatus 1 is fixed with a tripod or in other situation where a so-called shake does not occur, the necessary movement may not be obtained. Considering this, in the fourth application technique, optical characteristics are changed by driving a shake correction unit or the like when the input image sequence 400 is photographed. The shake correction unit is, for example; a shake correction lens (not shown) or the image sensor 33.

A specific example is described. It is supposed that n is two (see FIG. 11). The shake-correction unit (correction lens or image sensor 33), the aperture stop 32, the focus lens 31, and the zoom lens 30 which are described in the fourth application technique are those of the image pickup portion 11. In this case, the first distance detection result is generated by the first distance detecting process from the first and second input images photographed simultaneously at the time point t₁, and the shake correction unit, the aperture stop 32, the focus lens 31, or the zoom lens 30 is driven in the period between the time points t₁ and t₂. Thus, optical characteristics of the image pickup portion 11 are changed in the period between the time points t₁ and t₂. After that, the first and second input images are photographed (or only the first input image is photographed) at the time point t₂, so that the second distance detection result is obtained by the second distance detecting process based on the first input images at the time points t₁ and t₂. The combining portion 53 generates the output distance information from the first and second distance detection results.

If the shake correction unit is the correction lens, the correction lens is disposed in the optical system 35 of the image pickup portion 11. The incident light from the subject group enters the image sensor 33 through the correction lens. By changing the position of the correction lens or the image sensor 33 in the period during the time points t₁ and t₂, optical characteristics of the image pickup portion 11 are changed, and a parallax necessary for the second distance detecting process by the SFM is generated between the first input images at the time points t₁ and t₂. The same is true in the case of driving the aperture stop 32, the focus lens 31, or the zoom lens 30. The opening degree of the aperture stop 32 (namely, the aperture stop value), the position of the focus lens 31, or the position of the zoom lens 30 is changed in the period during the time points t₁ and t₂. Thus, optical characteristics of the image pickup portion 11 are changed, and the parallax necessary for the second distance detecting process by the SFM is generated between the first input images at the time points t₁ and t₂.

According to the fourth application technique, even in the case where the image pickup apparatus 1 is fixed with a tripod or in other situation where a so-called shake does not occur, the parallax necessary for the second distance detecting process by the SFM can be secured.

—Fifth Application Technique—

A fifth application technique will be described. In the first embodiment, the example of holding only image data of the first input image (input images 400[1] to 400[n−1]) in the image holding portion 54 is described above. However, it is possible to hold not only the image data of the first input image but also the image data of the second input image in the image holding portion 54 and to use the first input image sequence and the second input image sequence to detect the subject distance by the SFM. For instance, it is possible to use the first input images photographed at the time points t₁ and t₂ and the second input images photographed at the time points t₁ and t₂ to detect the subject distance by the SFM. Thus, detection accuracy of the subject distance by the SFM can be improved. In addition, if the image data of the first and second input images are held in the image holding portion 54, the detecting portion 51 can perform the first distance detecting process using the image data held in the image holding portion 54.

However, if it is known that the near subject is the photographing target though the image data of the first and second input images are held by the image holding portion 54 in principle, only the image data of the input image sequence 400 as the first input image sequence may be held by the image holding portion 54. Thus, memory space can be saved. Saving of the memory space enables to reduce process time, power consumption, cost, and resources. For instance, if the action mode of the image pickup apparatus 1 is set to a macro mode suitable for photographing a near subject, it can be decided that the near subject is the photographing target. Alternatively, for example, an input image that has been photographed before the time point t₁ may be used to decide whether or not the photographing target is the near subject.

In addition, for example, if it is known that the near subject is the photographing target, execution of the photographing operation of the input image that are necessary only for the first distance detecting process and execution of the first distance detecting process may be stopped, and the output distance information may be generated based on only the second distance detection result.

—Sixth Application Technique—

A sixth application technique will be described. The combining portion 53 according to the sixth application technique compares the first distance detection result with the second distance detection result. Then, only in the case where the subject distance values thereof are substantially the same, the combining portion 53 includes (incorporates) the substantially same subject distance value in the output distance information.

For instance, a subject distance DST₁(x, y) indicated by the pixel value VAL₁(x, y) at the pixel position (x, y) in the first range image is compared with a subject distance DST₂(x, y) indicated by the pixel value VAL₂(x, y) at the pixel position (x, y) in the second range image. Then, only in the case where an absolute value of the distance difference |DST₁(x, y)−DST₂(x, y)| is a predetermined reference value or smaller, the pixel value VAL₁(x, y) or VAL₂(x, y), or an average value of the pixel values VAL₁(x, y) and VAL₂(x, y) is written at the pixel position (x, y) in the combination range image. Thus, distance accuracy of the output distance information is improved. If the above-mentioned absolute value |DST₁(x, y)−DST₂(x, y)| is larger than a predetermined reference value, pixel values of pixels close to the pixel position (x, y) may be used to generate the pixel value at the pixel position (x, y) in the combination range image by interpolation.

—Seventh Application Technique—

A seventh application technique will be described. In the distance information generating portion 50, a specific distance range (hereinafter referred to as a first permissible distance range) is determined for the first distance detecting process, and a specific distance range (hereinafter referred to as a second permissible distance range) is determined for the second distance detecting process. The first permissible distance range is a distance range supposing that detection accuracy of the subject distance by the first distance detecting process is within a predetermined permissible range. The second permissible distance range is a distance range supposing that detection accuracy of the subject distance by the second distance detecting process is within a predetermined permissible range. Each of the first and second permissible distance ranges may be a fixed distance range or may be set one by one in accordance with a photographing condition (shake amount, zoom magnification, and the like). FIG. 15 illustrates an example of the first and second permissible distance ranges. The first and second permissible distance ranges are different from each other, and in particular, a lower limit distance of the first permissible distance range is larger than a lower limit distance of the second permissible distance range. In the example illustrated in FIG. 15, a part of the first permissible distance range and a part of the second permissible distance range are overlapped with each other, but there may be no overlapping (for example, the lower limit distance of the first permissible distance range may be the same as the upper limit distance of the second permissible distance range).

The combining portion 53 performs the combining process while considering the first and second permissible distance ranges. Specifically, if the subject distance DST₁(x, y) indicated by the pixel value VAL₁(x, y) of the first range image is within the first permissible distance range, the pixel value VAL₁(x, y) is written at the pixel position (x, y) in the combination range image. On the other hand, if the subject distance DST₂(x, y) indicated by the pixel value VAL₂(x, y) of the second range image is within the second permissible distance range, the pixel value VAL₂(x, y) is written at the pixel position (x, y) in the combination range image. If the subject distance DST₁(x, y) is within the first permissible distance range, and simultaneously the subject distance DST₂(x, y) is within the second permissible distance range, the pixel value VAL₁(x, y) or VAL₂(x, y), or an average value of the pixel values VAL₁(x, y) and VAL₂(x, y) is written at the pixel position (x, y) in the combination range image. Thus, the detection result outside the permissible distance range is not adopted as the output distance information (combination range image). As a result, distance accuracy of the output distance information is improved.

—Eighth Application Technique—

An eighth application technique will be described. If the subject corresponding to the pixel position (x, y) is the near subject or the end subject, the subject distance of the subject cannot be detected by the triangulation principle based on the parallax between the image pickup portions 11 and 21. In this case, in order that the pixel position (x, y) of the first range image also has a valid pixel value, the detecting portion 51 can perform interpolation for the pixel value VAL₁(x, y) using pixel values of pixels close to the pixel position (x, y) in the first range image. This interpolation method can be applied also to the second range image and the combination range image. By this interpolation, all pixel positions, can have valid distance information.

### Sixth Embodiment

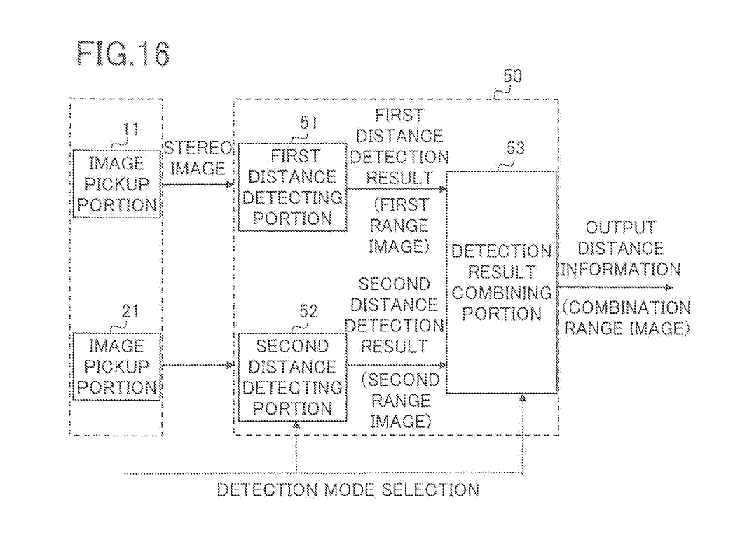

A sixth embodiment of the present invention will be described. In the first to fourth embodiments, the detection methods A1 to A4 and the combining methods B1 to B3 are described individually. Here, it is possible to adopt a structure in which the distance information generating portion 50 can select one of the detection methods and one of the combining methods. For instance, as illustrated in FIG. 16, the detecting portion 52 and the combining portion 53 may be supplied with a detection mode selection signal. The detection mode selection signal may be generated by the main control portion 13. The detection mode selection signal designates one of the detection methods A1 to A4 to be used for performing the second distance detecting process and one of the combining methods B1 to B3 to be used for generating the output distance information.

### Variations

The embodiments of the present invention can be modified variously in the scope of the technical concept of the present invention described in the attached claims. The embodiments described above, are merely examples of the embodiment of the present invention, and meanings of the present invention and terms of individual elements are not limited to those described in the embodiments. The specific values described above are merely examples and can be changed variously as a matter of course. As annotations that can be applied to the embodiments described above, Notes 1 to 4 are described below: Contents of the Notes can be combined arbitrarily as long as no contradiction arises.

### Note 1

In the embodiments described above, a method of detecting the subject distance by pixel unit is mainly described, but it is possible to detect the subject distance by small region in the embodiments. The small region is formed of one or more pixels. If the small region is formed of one pixel, the small region has the same meaning as the pixel.

### Note 2

In the above description, the example in which the output, distance information is used for the digital focus is described. However, the use example of the output distance information is not limited to this, and it is possible to use the output distance information for generating a three-dimensional image, for example.

### Note 3

The distance information generating portion 50 illustrated in FIG. 6 and the digital focus portion 60 illustrated in FIG. 8 may be disposed in electronic equipment (not shown) other-than the image pickup apparatus 1, and the above-mentioned operations may be performed in the electronic equipment. The electronic equipment is, for example, a personal computer, a mobile information terminal, a mobile phone, or the like. Note that the image pickup apparatus 1 is also one type of the electronic equipment.

### Note 4

The image pickup apparatus 1 illustrated in FIG. 1 and the above-mentioned electronic equipment may be constituted of hardware or a combination of hardware and software. If the image pickup apparatus 1 and the electronic equipment are constituted of software, a block diagram of a portion realized by software indicates a function block diagram of the portion. In particular, a whole or a part of functions realized by the distance information generating portion 50 and the digital focus portion 60 may be described as a program, and the program may be executed by a program executing device (for example, a computer) so that a whole or a part of the functions are realized.

What is claimed is:

1. An electronic equipment equipped with a distance information generating portion that generates distance information of a subject group, the distance information generating portion comprising:
a first distance detecting portion that detects a distance of the subject group based on a plurality of input images obtained by simultaneously photographing the subject group from different visual point;
a second distance detecting portion that detects a distance of the subject group by a detection method different from the detection method of the first distance detecting portion; and
a combining portion that generates the distance information based on a detection result of the first distance detecting portion and a detection result of the second distance detecting portion.

2. The electronic equipment according to claim 1, wherein the second distance detecting portion detects the distance of the subject group based on an image sequence obtained by sequentially photographing the subject group.

3. The electronic equipment according to claim 1, wherein the second distance detecting portion detects the distance of the subject group based on an output of an image sensor having phase difference pixels for detecting the distance of the subject group.

4. The electronic equipment according to claim 1, wherein the second distance detecting portion detects the distance of the subject group based on a single image obtained by photographing the subject group by a single image pickup portion.

5. The electronic equipment according to claim 1, wherein the combining portion
incorporates a detected distance of the first distance detecting portion for a target subject into the distance information if a distance of the target subject included in the subject group is relatively large, and
incorporates a detected distance of the second distance detecting portion for the target subject into the distance information if the distance of the target subject is relatively small.

6. The electronic equipment according to claim 1, further comprising a focused state changing portion that changes a focused state of a target image obtained by photographing the subject group, by image processing based on the distance information.
